(19) United States
(12) Patent Application Publication
(10) Pub. No.: US 2010/0139348 A1
(43) Pub. Date: Jun. 10, 2010

(54) CONTROLLED-RELEASE FERTILIZER COATED WITH A WAX LAYER AND A POLYMER LAYER AND METHOD OF PREPARING THE SAME

(76) Inventors: Lianbu WAN, Linyi (CN); Hongkun CHEN, Linyi (CN); Li LI, Linyi (CN); Bing YU, Linyi (CN); Li YANG, Linyi (CN)

Correspondence Address: MATTHIAS SCHOLL, 14781 MEMORIAL DRIVE, SUITE 1319, HOUSTON, TX, 77079, US

(21) Appl. No.: 12/705,646

(22) Filed: Feb. 15, 2010

Related U.S. Application Data
(63) Continuation of application No. PCT/CN2008/000711, filed on Apr. 8, 2008.

(30) Foreign Application Priority Data
Aug. 15, 2007 (CN) 200710141887.6

(51) Int. Cl. C05F 11/00

(52) U.S. Cl. 71/23; 71/27

(57) ABSTRACT

A controlled-release fertilizer having a fertilizer core and a coating applied thereon, the coating comprising a wax film layer and a polymer film layer. A method of preparation of the controlled-release fertilizer.

### CROSS-REFERENCE TO RELATED APPLICATIONS

This application is a continuation of International Patent Application No. PCT/CN2008/000711 with an international filing date of Apr. 08, 2008, designating the United States, now pending, and further claims priority benefits to Chinese Patent Application No. 200710141887.6 filed Aug. 15, 2007. The contents of all of the aforementioned applications, including any intervening amendments thereto, are incorporated herein by reference.

### BACKGROUND OF THE INVENTION

1. Field of the Invention

The invention relates to a controlled-release fertilizer and a preparation method, and more particularly to a controlled-release fertilizer coated with an aqueous polymer-wax and a preparation method.

2. Description of the Related Art

Fertilizers play an important role in agriculture. Conventional fertilizer application methods readily cause a loss thereof, which wastes resources and also seriously pollutes water, soil, and air. Finding a method to reduce the fertilizer rate and improve fertilizer-use efficiency is an urgent problem that needs to be solved for the sustainable development of agriculture. An effective way to achieve this goal is to develop a highly-effective and environment-friendly controlled-release fertilizer.

As they have excellent controlled-release properties for nutrients, controlled-release fertilizers coated with polymers have gained more and more attention around the world. Industrialization has been achieved. Typical examples include a controlled-release fertilizer coated with thermosetting resins from U.S. Scotts Company and a controlled release fertilizer coated with thermoplastic resins from Chisso-Asahi Fertilizer Co., Ltd. (Japan). However, in a controlled-release fertilizer coated with thermosetting resins, the coating agent of the polymer used therein has a high production cost and complicated production process, which increases the cost of the fertilizer and making it difficult to popularize. For a controlled-release fertilizer coated with thermoplastic resins, aside from the high cost of the polymer coating agent, a large amount of organic solvent is involved, which wastes energy and resources, and is also harmful to humans and the environment. Although a solvent recovery system is added during production, the small amount of organic solvent remaining in products will slowly volatilize and pollute the environment during storage and application. Furthermore, for the two kinds of controlled release fertilizer mentioned above, although the nutrient is completely released, it takes a long time for the polymer residues to degrade and thus may pollute the soil for a long period of time.

Controlled-release properties of a controlled release fertilizer are determined by the coating material. In the process of producing fertilizer, as an aqueous polymer coating agent only needs the removal of water, the equipment used is simple, industrialization is easily realized, and the resultant fertilizer has low costs and causes no pollution as organic solvents are not used. A coating agent of an aqueous polymer may consist of a water-dispersible resin or a water-soluble resin. However, for a coating agent of an aqueous polymer, rapid water-soluble fertilizer particles, such as urea and potassium sulfate, will dissolve during coating, which reduces the controlled-release properties of nutrients and affects the quality of the fertilizer.

Therefore, the disadvantages of an aqueous polymer coating agent needs to be overcome so as to give full play to the advantages of low cost and environmental friendliness of aqueous-polymer coated controlled-release fertilizers.

### SUMMARY OF THE INVENTION

In view of the above-described problems, one objective of the invention is to provide a controlled-release fertilizer that does not pollute, is low cost, and can effectively prevent the dissolution of the fertilizer during coating.

Another objective of the invention is to provide a method for producing a controlled-release fertilizer that does not pollute, is low cost, and can effectively prevent the dissolution of the fertilizer during coating.

To achieve the above objectives, in accordance with one embodiment of the invention, there is provided a controlled-release fertilizer comprising a fertilizer core and a coating applied thereon, wherein the coating comprises a wax film layer and as a coating agent a polymer film layer comprising an aqueous polymer emulsion and a biodegradable natural macromolecule.

In a class of this embodiment, the wax is a liquid wax or a solid wax having a melting point of less than 60° C.

In a class of this embodiment, the weight of the wax film is between 0.3 and 5% of the total weight of the fertilizer.

In a class of this embodiment, the weight of the polymer film is between 5 and 20% of the total weight of the fertilizer.

In a class of this embodiment, the aqueous polymer emulsion is, at presence of an initiator, an emulsifier, and a co-emulsifier, polymerized by a hard monomer, a soft monomer, and a functional monomer of an unsaturated acid capable of free radical polymerization, a weight ratio of the hard monomer to the soft monomer being between 2:1 and 1:2, and the functional monomer being between 0.2 and 15 wt.% of the total weight of all monomers.

In a class of this embodiment, the hard monomer is a styrene monomer, methyl methacrylate, or a mixture thereof, the soft monomer is an acrylate represented by formula of CH₂═CH—C(0)OR, or a mixture thereof, wherein R represents a straight-chain or a branched-chain C₁₋₁₈alkyl, and the functional monomer is acrylic acid, methacrylic acid, butene diacid, or a mixture thereof.

In a class of this embodiment, the emulsifier is an anionic emulsifier or a mixture of an anionic emulsifier and a non-ionic emulsifier.

In a class of this embodiment, the anionic emulsifier is RCOONa, ROSO₃Na, RSO₃Na, RC₆H₄SO₃Na, wherein R represents C₁₂₋₁₈alkyl, sodium alkyl diphenyl ether disulphonate, disproportionated rosin, sodium alkyl naphthalene sulfonate, or a mixture thereof, the non-ionic emulsifier is polyoxyethylene sorbitan fatty acid ester, alkylphenol polyoxyethylene ether, alkyl polyoxyethylene ether, or a mixture thereof, and the co-emulsifier is a long-chain fatty alcohol having eight or more carbon atoms.

In a class of this embodiment, based on the total weight of the monomers, the anionic emulsifier accounts for between 0.3 and 5.0 wt. %, the non-ionic emulsifier accounts for between 0 and 5.0 wt. %, and the co-emulsifier accounts for between 0 and 1.0 wt. %.

In a class of this embodiment, the polymerization is achieved by a semi-continuous emulsion polymerization process, a seed emulsion polymerization process, or a pre-emulsion polymerization process.

In a class of this embodiment, the initiator is added in batches.

In a class of this embodiment, the temperature for the emulsion polymerization is between 60 and 95° C., and the time for the emulsion polymerization is between 3 and 12 hrs.

In a class of this embodiment, the solid content of the aqueous polymer emulsion is between 20 and 70%.

In a class of this embodiment, at dry state, the particle size of the polymer is between 30 and 2000 nm.

In a class of this embodiment, the glass transition temperature of the polymer is between 5 and 65° C.

In a class of this embodiment, the biodegradable natural macromolecule is corn starch, potato starch, wheat starch, sweet potato starch, flour, cereal flour, or a mixture thereof.

In a class of this embodiment, the coating agent is prepared by dispersing the biodegradable natural macromolecule in water to form a paste, and mixing this with the aqueous polymer emulsion.

In a class of this embodiment, based on a dry weight of the coating agent, the aqueous polymer emulsion accounts for between 80 and 99 wt. %, and the biodegradable natural macromolecule accounts for between 1 and 20 wt. %.

In a class of this embodiment, the polymer film layer was coated with an inorganic layer comprising inorganic powder.

In a class of this embodiment, the weight of the inorganic powder is between 0.3 and 10% of the total weight of the fertilizer.

In accordance with another embodiment of the invention, there is provided a method for preparing a controlled-release fertilizer, comprised of a fluidized bed, (a) providing a fertilizer particle, (b) coating of the fertilizer particle with a wax film layer, and (c) coating the wax film layer with a polymer film layer as a coating agent comprising an aqueous polymer emulsion and a biodegradable natural macromolecule.

In a class of this embodiment, the temperature in the fluidized bed is between 30 and 80° C., the spraying temperature of the wax film layer is between 0 and 80° C., and the spraying temperature of the coating agent is between 30 and 60° C.

In a class of this embodiment, the method further comprises coating the polymer film layer with an inorganic layer comprising inorganic powder.

In a class of this embodiment, the coating temperature of the inorganic powder is between 30 and 80° C.

In the invention, prior to applying the aqueous polymer film layer, the fertilizer particle has been coated with the wax film layer, and thereby the dissolution of the fertilizer is effectively prevented, and the conventional disadvantages resulting from conventional coating methods are solved, and the fertilizer of the invention exhibits better controlled-release properties.

Preferably, an inorganic layer comprised of inorganic powder is coated on the polymer film layer. Aside from providing anti-stick and anti-wear, the inorganic layer can further regulate the release of the nutrient.

Advantages of the invention are summarized below: the controlled-release fertilizer has low cost, exhibits good properties of anti-impact, anti-wear, and controlled release, causes no pollution either in production or in use, and polymer residues can be degraded by microorganisms, so this is an environment-friendly product.

### BRIEF DESCRIPTION OF THE DRAWINGS

The invention is described herein below with reference to accompanying drawings, in which:

FIG. 1 is a sectional view of a controlled release fertilizer coated with aqueous polymer-wax according to one embodiment of the invention; a controlled-release fertilizer coated with an aqueous polymer-wax comprised of a fertilizer core, a wax film layer, and a polymer film layer from inside to outside.

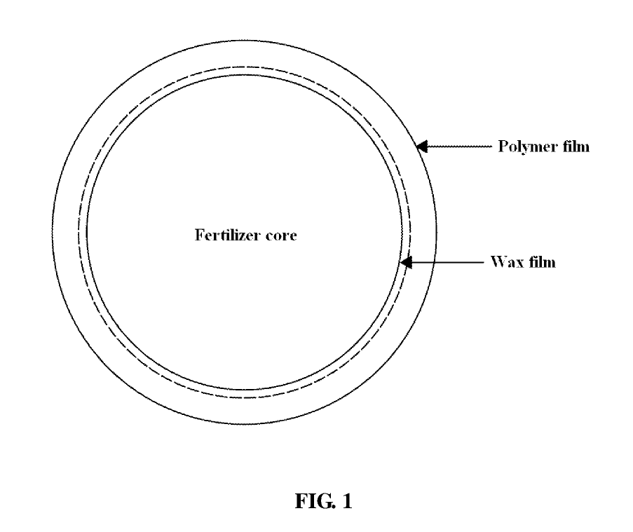

### DETAILED DESCRIPTION OF THE EMBODIMENTS

To further illustrate the invention, experiments detailing a controlled-release fertilizer and a method for preparing the same are described below. It should be noted that the following examples are intended to describe and not to limit the invention.

In the invention, an aqueous polymer emulsion is prepared with an unsaturated monomer emulsion, and then mixed with a biodegradable natural macromolecule to yield a coating agent.

Based on the dry weight of the coating agent, the aqueous polymer emulsion preferably accounts for between 80 and 99 wt. %, and the biodegradable natural macromolecule preferably accounts for between 1 and 20 wt. %.

1. Preparation of the Aqueous Polymer Emulsion

Preferably, the aqueous polymer emulsion is, at presence of an initiator, an emulsifier, and optionally a co-emulsifier, prepared by a hard monomer, a soft monomer, and a functional monomer of an unsaturated acid capable of free radical polymerization, a weight ratio of the hard monomer to the soft monomer being between 2:1 and 1:2, and the functional monomer being between 0.2 and 15 wt. % of the total weight of the monomers.

Preferably, the hard monomer is selected from the group consisting of a styrene monomer such as styrene and α-methyl styrene, methyl methacrylate, or a mixture thereof. The soft monomer is an acrylate represented by the formula CH₂═CH—C(O)OR, or a mixture thereof, wherein R represents a straight-chain or a branched-chain C₁₋₁₈alkyl, particularly methyl, ethyl, butyl, 2-ethylhexyl, or octadecyl. The functional monomer is an unsaturated acid capable of free radical polymerization, particularly acrylic acid, methacrylic acid, butene diacid, or a mixture thereof.

The glass transition temperature of the polymer can be adjusted by controlling the weight ratio of the hard monomer to the soft monomer, the temperature being between 5 and 65° C., particularly between 15 and 50° C., and more particularly between 25 and 45° C., the weight ratio of the hard monomer to the soft monomer being between 2:1 and 1:2, particularly between 1.8:1 and 1:1.5, and more particularly between 1.5:1 and 1:1.2, and the functional monomer being between 0.2 and 15 wt. % of the total weight of all monomers, particularly between 0.5 and 5 wt. %.

Preferably, the emulsifier is an anionic emulsifier or a mixture of an anionic emulsifier and a non-ionic emulsifier, the anionic emulsifier selected from the group consisting of RCOONa, ROSO₃Na, RSO₃Na, RC₆H₄SO₃Na, wherein R represents C₁₂₋₁₈alkyl, sodium alkyl diphenyl ether disulphonate, disproportionated rosin, sodium alkyl naphthalene sulfonate (Nekal BX), or a mixture thereof, the non-ionic emulsifier selected from the group consisting of a polyoxyethylene sorbitan fatty acid ester, alkylphenol polyoxyethylene ether, alkyl polyoxyethylene ether, or a mixture thereof. The co-emulsifier is preferably a long-chain fatty alcohol having eight or more carbon atoms, for example, N-octanol, iso-octanol, and dodecanol.

The anionic emulsifier is used separately or in combination with the non-ionic emulsifier, based on the total weight of the monomers, the anionic emulsifier accounts for between 0.3 and 5.0 wt. %, particularly between 1.0 and 3.0 wt. %, the non-ionic emulsifier accounts for between 0 and 5.0 wt. %, particularly between 0 and 3.0 wt. %, the co-emulsifier accounts for between 0 and 1.0 wt. %, particularly between 0 and 0.3 wt. %.

In the invention, the initiator is a thermal initiator and a redox initiator, particularly a persulphate initiator, such as ammonium persulfate, potassium persulfate or sodium persulfate, based on the total weight of the monomers, the initiator accounts for between 0.2 and 2.0 wt. %, particularly between 0.5 and 1 wt. %.

Preferably, the polymerization of emulsion is achieved at presence of a conventional buffer such as ammonium bicarbonate or sodium bicarbonate. Based on the total weight of the monomers, the buffer accounts for between 0.3 and 2.0 wt. %.

The temperature for emulsion polymerization is preferably between 60 and 95° C. The time for emulsion polymerization is preferably between 3 and 12 hrs. The solid content of the aqueous polymer emulsion is between 20 and 70 wt. %, particularly between 35 and 50 wt. %, the viscosity thereof is between 10 and 2000 mPa·s, and particularly between 30 and 500 mPa·s.

Preferably, the emulsion polymerization is achieved by conventional methods, particularly a semi-continuous emulsion polymerization process, a seed emulsion polymerization process, or a pre-emulsion polymerization process.

(1) Semi-Continuous Emulsion Polymerization Process

In the process, the initiator and the monomers are added in batches respectively. Preferably, to a reaction vessel having water, the emulsifier, and the buffer, part of monomer mixture (particularly between 5 and 30 wt. %) comprising the hard monomer, the soft monomer, and the functional monomer, is added. The reaction vessel is heated to temperature, for example 60° C., and then part of the initiator (particularly between 50 and 70 wt. %), together with the rest of the monomer mixture are added. The addition rate of the monomer is controlled so that the reaction system is maintained at a set temperature. Following addition of the monomer mixture, the rest of the initiator is added. The resultant mixture is allowed to react for a while at a specified temperature. Preferably, the addition time of the rest of the monomer mixture is between 1.5 and 5 hrs, and the total reaction time is between 3 and 10 hrs.

(2) Seed Emulsion Polymerization Process

To a reaction vessel having water, the emulsifier, and the buffer, the functional monomers, between 10 and 30 wt. % of the hard monomer, and between 10 and 30 wt. % of the soft monomer are added. The reaction vessel is heated to a temperature, for example 60° C., and then between 30 and 50 wt. % of the initiator is added and allowed to react for between 0.5 and 2.0 hrs, particularly between 1 and 1.5 hrs. Subsequently, the rest of the monomer mixture is added at a uniform speed, followed by the rest of the initiator. The resultant mixture is allowed to react for a while at the specified temperature. Preferably, the addition time of the rest of the monomer mixture is between 1 and 3 hrs, and the total reaction time is between 5 and 12 hrs.

(3) Pre-Emulsion Polymerization Process

In the process, a monomer pre-emulsion is involved and the initiator is added in batches. Preferably, to a reaction vessel, between 40 and 70 wt. % of water, between 50 and 70 wt. % of the emulsifier, and between 60 and 90 wt. % of a monomer mixture are added, at between 0 and 60° C., stirred for between 0.5 and 1.5 hrs, particularly between 0.6 and 1.0 h, and a monomer pre-emulsion is prepared. The rest of the water, the rest of the emulsifier, the co-emulsifier, and the rest of monomer mixture are added to the reaction vessel. The reaction vessel is heated to a temperature, for example 60° C., and then between 30 and 70 wt. % of an initiator, together with the rest of the monomer pre-emulsion are added at a uniform speed, and followed by the rest of the initiator. The resultant mixture is allowed to react for a while at the temperature. Preferably, the addition time of the monomer pre-emulsion is between 1 and 3 hrs, and the total reaction time is between 5 and 12 hrs.

In the invention, the emulsion particle size of the polymer is determined by the type of the emulsifier, the used amount thereof, and the used amount of the functional monomer. At dry state, the particle size is between 30 and 2000 nm, particularly between 40 and 600 nm, and more particularly between 50 and 100 nm. An emulsion particle of nanometer grade is preferable, with advantages in forming a stable emulsion and dense polymer film.

2. Preparation of Aqueous Polymer as a Coating Agent

In the invention, an aqueous polymer emulsion is mixed with a biodegradable natural macromolecule to yield an aqueous polymer as a coating agent.

Preferably, the weight ratio of the aqueous polymer emulsion to the biodegradable natural macromolecule is between 80:20 and 99:1 (dry weight), at a temperature of between 10 and 50° C.

The biodegradable natural macromolecule is selected from a group consisting of starch such as corn starch, potato starch, wheat starch, and sweet potato starch, flour, cereal flour such as rice flour, or a mixture thereof.

The mixing method for the aqueous polymer emulsion with the biodegradable natural macromolecule is flexible, for example, the natural biodegradable macromolecule is directly added to the aqueous polymer emulsion with stirring. Optionally, the natural biodegradable macromolecule is first dispersed into water to form a paste, and then mixed with the aqueous polymer emulsion, for example, a certain concentration of the biodegradable natural macromolecule, e.g., between 15 and 20 wt. %, first dispersed in cold water, heated to between 60 and 90° C. for paste formation for a time period, particularly between 0.5 and 1.5 hrs, and then mixed with the aqueous polymer emulsion.

3. Coating of Fertilizer

The aqueous polymer as a coating agent can be used singly or in combination with any other coating agent, and it is suitable for any aqueous fertilizer. The fertilizer is a single fertilizer selected from a nitrogen fertilizer such as urea, a phosphate fertilizer such as ammonium phosphate, or a potash fertilizer such as potassium sulfate, or a compound fertilizer having a random NPK ratio, a mixed fertilizer, or other water-soluble plant nutrients.

In the invention, the wax is a liquid wax and is a low melting-point wax from the oil industry, for example, with a melting point of less than 60° C., particularly a solid wax with a melting point of less than 40° C.

A method for preparing a controlled-release fertilizer, comprised in a fluidized bed, (a) providing a fertilizer particle, (b) coating of the fertilizer particle with a wax film layer, (c) coating the wax film layer with a polymer layer as a coating agent comprising an aqueous polymer emulsion and a biodegradable natural macromolecule, and optionally (d) coating the polymer film layer with an inorganic layer comprising inorganic powder.

When applying the polymer film layer as a coating agent, a spraying method is preferable. A fluidized bed is preferably in the form of a boiling type or rotating drum. More particularly, spraying with a double nozzle is preferable.

The temperature in the fluidized bed is preferably between 30 and 80° C. The spraying temperature of the wax film is preferably between 0 and 80° C., and more preferably between 40 and 60° C. The spraying temperature of the coating agent is preferably between 30 and 60° C. The coating temperature of the inorganic powder is preferably between 30 and 80° C.

Specifically, a fertilizer particle is added to a fluidized bed in the form of a boiling type or rotating drum, and heated to between 40 and 80° C. A liquid wax preferably preheated to between 40 and 60° C. is sprayed with a double nozzle on to the fertilizer and therein a uniform liquid coating is formed. The smaller the particle size, the larger the usage amount for the wax. Generally, the weight of the wax is between 0.3 and 5% of the total weight of the fertilizer, particularly between 0.5 and 3%. Subsequently, an aqueous polymer as a coating agent preheated to preferably between 30 and 60° C. is sprayed on to the wax-coated fertilizer and therein a continuous and uniform polymer film layer is formed. Preferably, the aqueous polymer is sprayed on to the wax-coated fertilizer with a double nozzle.

The usage amount of the aqueous polymer is determined by the particle size of the fertilizer and the demand on release rate of nutrient. Generally, the weight of the aqueous polymer is between 5 and 20% of the total weight of the fertilizer, particularly between 6 and 15%.

As needed, an inorganic powder is sprayed into the fluidized bed so as to adhere to the aqueous polymer-coated fertilizer. Generally, at dry state, the weight of the inorganic powder is between 0.3 and 10% of the total weight of the fertilizer, particularly between 0.5 and 5%, and more particularly between 1 and 3%.

The inorganic powder is selected from a group consisting of talcum powder, diatomite, montmorillonite, kaolin, calcium carbonate, bentonite, attapulgite, sepiolite powder, or a mixture thereof, particularly talcum powder, diatomite, and calcium carbonate, and more particularly nanometer inorganic powder. The particle size of the inorganic powder is less than 20 μm, particularly less than 10 μm, and more particularly less than 5 μm. Talcum powder, diatomite, and calcium carbonate less than 5 μm in particle size is the most preferable.

### EXAMPLES

In the invention, a monomer for preparation of an aqueous polymer is of polymerization grade. The emulsifier and buffer are industrial products. The initiator is an analytically pure reagent. The reaction medium is distilled water. The inorganic powder is industrial grade. The monomer conversion rate in a polymerization reaction is determined by a gravimetric method. Product viscosity at a temperature of lower than 25° C. is determined by a rotary viscometer. The latex particle size of the polymer is determined by an electron microscope. The glass transition temperature of the polymer is determined by a DSC method.

The nutrient release period of the controlled-release fertilizer is expressed as a duration (day) from the immersion of the fertilizer into still water having a temperature of 25° C. to the nutrient release rate of up to 80 wt. %. Specifically, a controlled-release fertilizer is immersed into still water having a temperature of 25° C., and the nutrient passes through the coating and is dissolved in the water. The total amount of dissolved nitrogen is determined by titration after distillation according to G8/T 8572. The total amount of dissolved phosphorus is determined by ammonium vanadate-molybdate colorimetry according to G8/T 8573. The total amount of dissolved potassium is determined by a flame photometer method according to G8/T 8574. The duration (days) from the immersion of the fertilizer into the still water to the total nutrient release rate of up to 80 wt. % is considered as the nutrient release period of the controlled-release fertilizer.

### Example 1

(1) Preparation of an Aqueous Polymer as a Coating Agent

A semi-continuous emulsion polymerization process is applied. To a round-bottom flask (3 L) equipped with a stirrer, a condenser, a thermometer, and a dropping funnel, 900 g of water, 13 g of sodium dodecyl sulfate, 6 g of n-octanol, and 8 g of ammonium bicarbonate was added and stirred until dissolved. 8 g of ammonium persulfate was dissolved in 100 g of water for further use. 510 g of styrene, 470 g of butyl acrylate, and 20 g of acrylic acid were mixed in the dropping funnel. 20% of the resultant monomer mixture was added to the flask and heated to 60° C., 60 mL of ammonium persulfate aqueous solution was added, and meanwhile the rest of the monomer mixture was dripped at a uniform speed. The reaction temperature was controlled at about 85° C. by adjusting the dripping speed. The dripping time was about 2 hrs. After that, the rest of the ammonium persulfate aqueous solution was added, and allowed to react for 4 hrs at about 85° C. The solution was cooled to room temperature, and the pH value thereof was adjusted to neutrality with 10% ammonia to yield a polymer emulsion having a viscosity of 34 mPa·s, a particle size of 76 nm, and a glass transition temperature of 38.2° C.

50 g of cornstarch was dispersed in 250 g of water, and heated with stirring to about 78° C. for pasting for an hour, and then the above-mentioned polymer emulsion was added with strong stirring and uniformly mixed to yield a coating agent.

(2) Coating of Fertilizer

10 kg of urea (manufactured by Shandong Mingshui Chemical Co., Ltd., N wt. %=46.4%) having a particle size of between 3 and 4 mm was added to a boiling-type fluidized bed, heated to about 65° C., and then 0.15 kg of liquid wax preheated to about 60° C. was sprayed on the urea particles with a double nozzle. 20 minutes later, 2 kg of the above-mentioned coating agent preheated to about 50° C. and was sprayed on the urea by another double nozzle, with a spraying speed of 100 g/min Based on the dry weight of the controlled-release fertilizer coated with aqueous polymer-wax, the urea accounts for about 90.2 wt. %, the polymer film layer about 8.4 wt. %, and the wax film layer about 1.4 wt. %. The nutrient release period was about 160 days.

### Example 2

(1) Preparation of an Aqueous Polymer as a Coating Agent

Equipment and the polymerization process were the same as that in Example 1 except that the amount added for methyl methacrylate was 450 g, butyl acrylate 490 g, acrylic acid 60 g, sodium dodecyl sulfate 10 g, octyl-phenyl polyoxyethylene ether 12 g, n-octanol 5 g, ammonium persulfate 12 g, ammonium bicarbonate 12 g, and water 1000 g. The resultant polymer emulsion has a viscosity of 48 mPa·s, a particle size of 82 nm, and a glass transition temperature of 25.1° C.

70 g of potato starch was dispersed in 300 g of water, and heated with stirring to about 75° C. for pasting for an hour, and then the above-mentioned polymer emulsion was added with strong stirring and uniformly mixed to yield a coating agent.

(2) Coating of Fertilizer

10 kg of urea (manufactured by Shandong Mingshui Chemical Co., Ltd., N wt. %=46.4%) having a particle size of between 3 and 4 mm was added to a boiling-type fluidized bed, heated to about 65° C., and then 0.1 kg of liquid wax preheated to about 60° C. was sprayed on the urea particles with a double nozzle. 20 min later, 1.5 kg of the above-mentioned coating agent preheated to about 45° C. was sprayed on the urea with another double nozzle, with a spraying speed of 100 g/min. Based on the dry weight of the controlled-release fertilizer coated with aqueous polymer-wax, the urea accounts for about 92.6 wt. %, the polymer film layer about 6.5 wt. %, and the wax film layer about 0.9 wt. %. The nutrient release period was about 130 days.

### Example 3

(1) Preparation of an Aqueous Polymer as a Coating Agent

The same as that in Example 2.

(2) Coating of Fertilizer

10 kg of urea (manufactured by Shandong Mingshui Chemical Co., Ltd., N wt. %=46.4%) having a particle size of between 3 and 4 mm was added to a boiling-type fluidized bed, heated to about 65° C., and then 0.1 kg of liquid wax preheated to about 60° C. was sprayed on the urea particles with a double nozzle. 20 min later, 1.5 kg of the above-mentioned coating agent preheated to about 45° C. was sprayed on the urea with another double nozzle, with a spraying speed of 100 g/min. Finally, 240 g of calcium carbonate having an average particle size of 3.5 μm was uniformly sprayed on the surface of the fertilizer having a temperature of about 65° C.

Based on the dry weight of the controlled-release fertilizer coated with aqueous polymer-wax, the urea accounts for about 90.6 wt. %, the polymer film layer about 6.3 wt. %, the wax film layer about 0.9 wt. %, the calcium carbonate about 2.2 wt. %. The nutrient release period was about 150 days.

### Example 4

(1) Preparation of an Aqueous Polymer as a Coating Agent

A Pre-emulsion Polymerization Process is applied. To a round-bottom flask, 500 g of water, 2.5 g of sodium dodecyl benzene sulfonate, 2.5 g of sodium dodecyl sulfate, and 4 g of polyoxyethylene sorbitan monoleate were added and stirred until dissolved. 390 g of styrene, 570 g of ethyl acrylate, and 40 g of acrylic acid were mixed uniformly, and then 80% of the resultant monomer mixture was added to the flask, emulsified at 700 rpm for 45 min at room temperature. The resultant monomer pre-emulsion was transferred to a dropping funnel. 10 g of potassium persulfate was dissolved in 100 g of water for further use.

To a round bottom flask (3 L) equipped with a stirrer, a condenser, a thermometer, and a dropping funnel, 400 g of water, 2.5 g of sodium dodecyl benzene sulfonate, 2.5 g of sodium dodecyl sulfate, 4 g of polyoxyethylene sorbitan monoleate, 4 g of n-octanol, and 15 g of sodium bicarbonate were added and stirred until dissolved. The rest of the monomer mixture (20%) was added to the flask and heated to 60° C., 60 mL of potassium persulfate aqueous solution added, and meanwhile the monomer pre-emulsion was dripped at a uniform speed. The reaction temperature was controlled at about 80° C. The dripping time was about 2 hrs. After that, the rest of the potassium persulfate aqueous solution (40 mL) was added, and allowed to react for 4 hrs at about 80° C. The solution was cooled to room temperature, and the pH value thereof was adjusted to neutrality to yield a polymer emulsion having a viscosity of 47 mPa·s, a particle size of 78 nm, and a glass transition temperature of 19.4° C.

60 g of cornstarch was dispersed in 250 g of water, and heated with stirring to about 80° C. for pasting for an hour, and then the above-mentioned polymer emulsion was added with strong stirring and uniformly mixed to yield a coating agent.

(2) Coating of Fertilizer

10 kg of potassium sulfate (manufactured by Shandong Kingenta Ecological Engineering Co., Ltd., K₂O wt. %=50%) having a particle size of between 3 and 5 mm was added to a boiling-type fluidized bed, heated to about 65° C., and then 0.15 kg of liquid wax preheated to about 50° C. was sprayed on the potassium sulfate with a double nozzle. 20 min later, 1.7 kg of the above-mentioned coating agent preheated to about 45° C. was sprayed on the urea with another double nozzle, with a spraying speed of 80 g/min Based on the dry weight of the controlled-release fertilizer coated with aqueous polymer-wax, potassium sulfate accounts for about 91.3 wt. %, the polymer film layer about 7.3 wt. %, and the wax film layer about 1.4 wt. %. The nutrient release period was about 110 days.

### Example 5

(1) Preparation of an Aqueous Polymer as a Coating Agent

A Pre-emulsion Polymerization Process is applied. To a round-bottom flask, 500 g of water, 2 g of sodium dodecyl sulfate, 3 g of dodecyl diphenyl ether disulphonate sodium, and 5 g of n-octyl phenol polyoxyethylene ether were added and stirred until dissolved. 450 g of styrene, 470 g of butyl acrylate, 12 g of octadecyl acrylater, and 60 g of methacrylic acid were mixed uniformly, and then 80% of the resultant monomer mixture was added to the flask, and emulsified at 700 rpm for 45 min at room temperature. The resultant monomer pre-emulsion was transferred to a dropping funnel. 14 g of ammonium persulfate was dissolved in 100 g of water for further use.

To a round-bottom flask (3 L) equipped with a stirrer, a condenser, a thermometer, and a dropping funnel, 400 g of water, 2 g of sodium dodecyl sulfate, 3 g of dodecyl diphenyl ether disulphonate sodium, 5 g of n-octyl phenol polyoxyethylene ether, 5 g of dodecanol, and 16 g of ammonium bicarbonate was added and stirred until dissolved. The rest of the monomer mixture (20%) was added to the flask and heated to 60° C., 60 mL of ammonium persulfate aqueous solution added, and meanwhile the monomer pre-emulsion was dripped at a uniform speed. The reaction temperature was controlled at about 80° C. The dripping time was about 2 hrs. After that, the rest of the ammonium persulfate aqueous solution (40 mL) was added, and allowed to react for 3.5 hrs at about 85° C. The solution was cooled to room temperature, and the pH value thereof was adjusted with 10% ammonia to neutrality to yield a polymer emulsion having a viscosity of 24 mPa·s, a particle size of 64 nm, and a glass transition temperature of 22.5° C.

50 g of cornstarch was dispersed in 250 g of water, and heated with stirring to about 78° C. for pasting for an hour, and then the above-mentioned polymer emulsion was added with strong stirring and uniformly mixed to yield a coating agent.

(2) Coating of Fertilizer

10 kg of potassium sulfate (manufactured by Shandong Kingenta Ecological Engineering Co. Ltd., K₂O wt. %=50%) having a particle size of between 3 and 5 mm was added to a boiling-type fluidized bed, heated to about 65° C., and then 0.1 kg of liquid wax preheated to about 50° C. was sprayed on the potassium sulfate with a double nozzle. 20 min later, 1.3 kg of the above-mentioned coating agent preheated to about 45° C. was sprayed on the urea with another double nozzle, with a spraying speed of 80 g/min. Based on the dry weight of the controlled-release fertilizer coated with aqueous polymer-wax, potassium sulfate accounts for about 93.4 wt. %, the polymer film layer about 5.7 wt. %, and the wax film layer about 0.9 wt. %. The nutrient release period was about 70 days.

### Example 6

(1) Preparation of an Aqueous Polymer as a Coating Agent

The same as that in Example 5.

(2) Coating of Fertilizer

10 kg of potassium sulfate (manufactured by Shandong Kingenta Ecological Engineering Co. Ltd., K₂O wt. %=50%) having a particle size of between 3 and 5 mm was added to a boiling-type fluidized bed, heated to about 65° C., and then 0.1 kg of liquid wax preheated to about 50° C. was sprayed on the potassium sulfate with a double nozzle. 20 min later, 1.3 kg of the above-mentioned coating agent preheated to about 45° C. was sprayed on the urea with another double nozzle, with a spraying speed of 80 g/min. Finally, 200 g of calcium carbonate having an average particle size of 3.5 μm was uniformly sprayed on the surface of the fertilizer having a temperature of about 65° C. Based on the dry weight of the controlled-release fertilizer coated with aqueous polymer-wax, potassium sulfate accounts for about 91.7 wt. %, the polymer film layer about 5.6 wt. %, the wax film layer about 0.9 wt. %, and calcium carbonate about 1.8 wt. %. The nutrient release period was about 80 days.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A controlled-release fertilizer comprising a fertilizer core and a coating applied thereon, wherein said coating comprises a wax film layer and as a coating agent a polymer film layer comprising an aqueous polymer emulsion and a biodegradable natural macromolecule.

2. The controlled-release fertilizer of claim 1, wherein said wax is a liquid wax or a solid wax having a melting point of less than 60° C.

3. The controlled-release fertilizer of claim 1, wherein a weight of said wax film is between 0.3 and 5% of the total weight of said fertilizer.

4. The controlled-release fertilizer of claim 1, wherein the weight of said polymer film is between 5 and 20% of the total weight of said fertilizer.

5. The controlled-release fertilizer of claim 1, wherein said aqueous polymer emulsion is, at presence of an initiator, an emulsifier, and a co-emulsifier, polymerized by a hard monomer, a soft monomer, and a functional monomer of an unsaturated acid capable of free radical polymerization, a weight ratio of said hard monomer to said soft monomer being between 2:1 and 1:2, and said functional monomer being between 0.2 and 15 wt. % of the total weight of said monomers.

6. The controlled-release fertilizer of claim 5, wherein said hard monomer is a styrene monomer, methyl methacrylate, or a mixture thereof, said soft monomer is an acrylate represented by formula of CH₂═CH—C(O)OR, or a mixture thereof, wherein R represents a straight-chain or a branched-chain C₁₋₁₈alkyl, and said functional monomer is acrylic acid, methacrylic acid, butene diacid, or a mixture thereof.

7. The controlled-release fertilizer of claim 5, wherein said emulsifier is an anionic emulsifier or a mixture of an anionic emulsifier and a non-ionic emulsifier.

8. The controlled-release fertilizer of claim 7, wherein said anionic emulsifier is RCOONa, ROSO₃Na, RSO₃Na, RC₆H₄SO₃Na, wherein R represents C₁₂₋₁₈alkyl, sodium alkyl diphenyl ether disulphonate, disproportionated rosin, sodium alkyl naphthalene sulfonate, or a mixture thereof, said non-ionic emulsifier is polyoxyethylene sorbitan fatty acid ester, alkylphenol polyoxyethylene ether, alkyl polyoxyethylene ether, or a mixture thereof, and said co-emulsifier is a long-chain fatty alcohol having eight or more carbon atoms.

9. The controlled-release fertilizer of claim 7, wherein based on the total weight of said monomers, said anionic emulsifier accounts for between 0.3 and 5.0 wt. %, said non-ionic emulsifier accounts for between 0 and 5.0 wt. %, and said co-emulsifier accounts for between 0 and 1.0 wt. %.

10. The controlled-release fertilizer of claim 5, wherein said polymerization is achieved by a semi-continuous emulsion polymerization process, a seed emulsion polymerization process, or a pre-emulsion polymerization process.

11. The controlled-release fertilizer of claim 5, wherein said initiator is added in batches.

12. The controlled-release fertilizer of claim 5, wherein the temperature for said emulsion polymerization is between 60 and 95° C., and the time period for said emulsion polymerization is between 3 and 12 hrs.

13. The controlled-release fertilizer of claim 5, wherein the solid content of said aqueous polymer emulsion is between 20 and 70%.

14. The controlled-release fertilizer of claim 5, wherein at dry state, the particle size of said polymer is between 30 and 2000 nm.

15. The controlled-release fertilizer of claim 5, wherein the glass transition temperature of said polymer is between 5 and 65° C.

16. The controlled-release fertilizer of claim 1, wherein said biodegradable natural macromolecule is corn starch, potato starch, wheat starch, sweet potato starch, flour, cereal flour, or a mixture thereof.

17. The controlled-release fertilizer of claim 1, wherein said coating agent is prepared by dispersing said biodegradable natural macromolecule in water to form a paste, and for mixing with said aqueous polymer emulsion.

18. The controlled-release fertilizer of claim 1, wherein based on the dry weight of said coating agent, said aqueous polymer emulsion accounts for between 80 and 99 wt. %, and said biodegradable natural macromolecule accounts for between 1 and 20 wt. %.

19. The controlled-release fertilizer of claim 1, wherein said polymer film layer was coated with an inorganic layer comprising inorganic powder.

20. The controlled-release fertilizer of claim 19, wherein the weight of said inorganic powder is between 0.3 and 10% of the total weight of said fertilizer.

21. A method of preparing a controlled-release fertilizer, comprising in a fluidized bed, (a) providing a fertilizer particle, (b) coating said fertilizer particle with a wax film layer, and (c) coating said wax film layer with a polymer film layer as a coating agent comprising an aqueous polymer emulsion and a biodegradable natural macromolecule.

22. The method of claim 21, wherein the temperature in said fluidized bed is between 30 and 80° C., the spraying temperature of said wax film layer is between 0 and 80° C., and the spraying temperature of said coating agent is between 30 and 60° C.

23. The method of claim 21, further comprising coating said polymer film layer with an inorganic layer comprising inorganic powder.

24. The method of claim 23, wherein a coating temperature of said inorganic powder is between 30 and 80° C.
